(19) United States
(12) Patent Application Publication
(10) Pub. No.: US 2026/0360026 A1
(43) Pub. Date: Nov. 12, 2026

(54) MULTI-SUBJECT IMAGE GENERATION WITH SUBJECT REGIONAL INFORMATION

(71) Applicant: QUALCOMM Incorporated, San Diego, CA (US)

(72) Inventors: Shubhankar Mangesh Borse, San Diego, CA (US); Munawar Hayat, San Diego, CA (US); Debasmit Das, San Diego, CA (US); Shreya Kadambi, San Diego, CA (US); Hyojin Park, San Diego, CA (US); Fatih Murat Porikli, San Diego, CA (US)

(21) Appl. No.: 19/420,293

(22) Filed: Dec. 15, 2025

Related U.S. Application Data
(60) Provisional application No. 63/803,098, filed on May 9, 2025.

(51) Int. Cl. G06T 11/00; G06N 3/045

(52) U.S. Cl. CPC G06T 11/00; G06N 3/045

(57) ABSTRACT

A device for image generation includes one or more memories and processing circuitry coupled to the one or more memories. The processing circuitry is configured to receive an input to generate an image that includes a plurality of subjects, apply a first neural network model to the input to generate subject regional information, and apply a second neural network model to the subject regional information to generate the image.

This application claims the benefit of U.S. Provisional Application No. 63/803,098, filed May 9, 2025, the entire contents of which are hereby incorporated by reference.

### TECHNICAL FIELD

This disclosure relates to image generation.

### BACKGROUND

For artificial intelligence (AI)/machine learning (ML) based image generation techniques, a user may provide images of subjects and contextual information about the image that includes the subjects. A neural network model may receive the user provided information and generate the image that includes the subjects according to the contextual information.

### SUMMARY

This disclosure relates generally to techniques and devices for generating images using AI/ML (i.e., AI/ML generated images). Processing circuitry may generate subject regional information about subjects that are to be included in an AI/ML generated image, and use the subject regional information for generating the AI/ML generate image. For example, processing circuitry may apply a first neural network model to generate the subject regional information (e.g., pose, segmentation, region images, etc.). The processing circuitry may be configured to apply a second neural network model (e.g., a large vision model) to the subject regional information, potentially using respective images of the respective subjects as input to the second neural network model, to generate the image.

By generating the subject regional information and applying the second neural network model to the subject regional information, the example techniques may improve the technology of image generation. For instance, some techniques may generate the image directly, without utilizing subject regional information. In those techniques, especially if there are many subjects, the image quality may be relatively poor, such as due to subject distortion, subject mixing, misalignment, etc. With the example techniques, the subject regional information may form an anchor, contour, bounding box, keypoints, etc. that the second neural network model can utilize for image generation, which in turn improves image quality relative to other techniques.

In one example, the disclosure describes a device for image generation, the device comprising: one or more memories; and processing circuitry coupled to the one or more memories and configured to: receive an input to generate an image that includes a plurality of subjects; apply a first neural network model to the input to generate subject regional information; and apply a second neural network model to the subject regional information to generate the image.

In one example, the disclosure describes a method of image generation, the method comprising: receiving, with processing circuitry, an input to generate an image that includes a plurality of subjects; applying, with the processing circuitry, a first neural network model to the input to generate subject regional information; and applying, with the processing circuitry, a second neural network model to the subject regional information to generate the image.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIG. 1 is a block diagram illustrating an example of a device according to the techniques of this disclosure.

FIGS. 2A–2C are conceptual diagrams illustrating examples of subject regional information.

FIG. 3A is a flow diagram illustrating an example of generating an image according to the techniques of this disclosure.

FIG. 3B is a flow diagram illustrating another example of generating an image according to the techniques of this disclosure.

FIG. 4 is a flow diagram illustrating an example of generating ground truth images for training a neural network model for generating subject regional information.

FIG. 5 is a conceptual diagram illustrating an example of a neural network model for generating subject regional information.

FIG. 6 is a flowchart illustrating an example method of generating an image according to the techniques of this disclosure.

FIGS. 7A and 7B are images illustrating different generated images.

### DETAILED DESCRIPTION

For artificial intelligence (AI)/machine learning (ML) based image generation, a user provides an input, such as a text-semantic input, that includes information indicative of a number of subject to generate in the image. In some examples, the user also provides images (e.g., thumbnail images) of the subjects. The input may further include contextual information useful for generating the image. For example, the text-semantic input may be “3 hikers in a forest.” In this example, the “hikers in a forest” may be the contextual information useful for generating the image.

Processing circuitry may apply a neural network model (e.g., execute the neural network model) that receives the text-semantic input and outputs the image. The neural network model may be tuned for generating such output images, examples of such neural network models include models trained using LoRA (low-rank adaptation) or Mixture of Experts (MoE). However, use of such models may not be appropriate for smaller sized devices like mobile devices due to the heavy processing overhead, and in any event, lack accuracy when the number of subjects is more than two subjects.

Zero-shot (e.g., tuning-free) techniques, such as MS-Diffusion, MIP Adaptor, etc. may be utilized to generate the neural network model. However, such neural network models still fail to generate multiple subjects, such as more than two subjects. Also, there may be misalignment, mixing artifacts, and other such distortions using such neural network models.

This disclosure describes example techniques that allow for use of tuned- or tuning-free (e.g., zero-shot) neural network models that generate accurate, visually pleasing images with multiple subjects. As described in more detail, rather than inputting the text-semantic input directly into the neural network model, a processing circuitry may apply a first neural network model to the input to generate subject regional information. The processing circuitry may apply a second neural network model (e.g., one of the tuned- or tuning-free neural network models described above) to the subject regional information to generate the image.

By processing the text-semantic input with the first neural network model to generate the subject regional information, the second neural network model may utilize the subject regional information as anchors, contours, bounding boxes, keypoints, etc. to more accurately place the subjects. In this manner, there may be reduced mixing artifacts, where image content of one subject is mixed with image content of another subject, and reduced misalignment, since the subject regional information provide guidance for where the subjects are to be placed and how the subjects are separated from one another.

There may be various examples of subject regional information. For instance, the subject regional information may include one or more pose images, each pose image representing a pose of the subjects, one or more segmentation images, each segmentation image representing a segmentation of the subjects, and/or one or more region images, each region image representing a region encompassed by the subjects.

In some examples, the text-semantic input may also include information indicative of relative locations of the subjects. For instance, the text-semantic input may be “3 hikers in the forest, and the person on the left is in ‘subject image1’, the person in the middle is in ‘subject image2’, and the person on the right is in ‘subject image3’”. In this example, the processing circuitry may apply the second neural network model to the subject regional information utilizing the information indicative of the relative locations of the subjects as input to the second neural network model to generate the image.

For purposes of illustration, the example techniques are described with respect to the subjects being human subjects. However, the example techniques are not so limited. Also, the first neural network model and the second neural network model may be two different neural network models. In some examples, it may be possible to form a composite neural network model, in which the first neural network model and the second neural network model are sub-models that may share resources. That is, it may be possible to end-to-end train the first neural network model and the second neural network model. Accordingly, this disclosure should not be considered limited to requiring two distinct neural network models, as such neural network models may be combined. However, this disclosure also contemplates examples with distinct neural network models.

In the above examples, the input is a text-semantic input. There may be various techniques to extract the semantic from the text-semantic input that is useable by the first and second neural network models. The techniques described in this disclosure are not limited to any particular way in which the semantics are extracted from the text-semantic input. Furthermore, the text-semantic input is one example, and input to the first or second neural network model need not be limited to a text-semantic input. For instance, the user may provide a verbal input, rather than typing in the text-semantic input. Other examples of inputs are possible, and the disclosure should not be considered limited to text-semantic inputs.

As noted above, there may be various examples of the subject regional information such as one or more pose images, one or more segmentation images, and/or one or more region images. In some examples, the first neural network model may generate one image as the subject regional information (e.g., one pose image, one segmentation image, and/or one region image). The second neural network model may utilize this one image as the subject regional information to generate the image that includes the subjects. In some examples, the first neural network model may generate a plurality of images as the subject regional information (e.g., a plurality of one or more pose images, one or more segmentation images, and/or one or more region images). The processing circuitry may receive a selection (e.g., user selection) for one of the images the subject regional information. The second neural network model may utilize this selected image as the subject regional information to generate the image that includes the subjects.

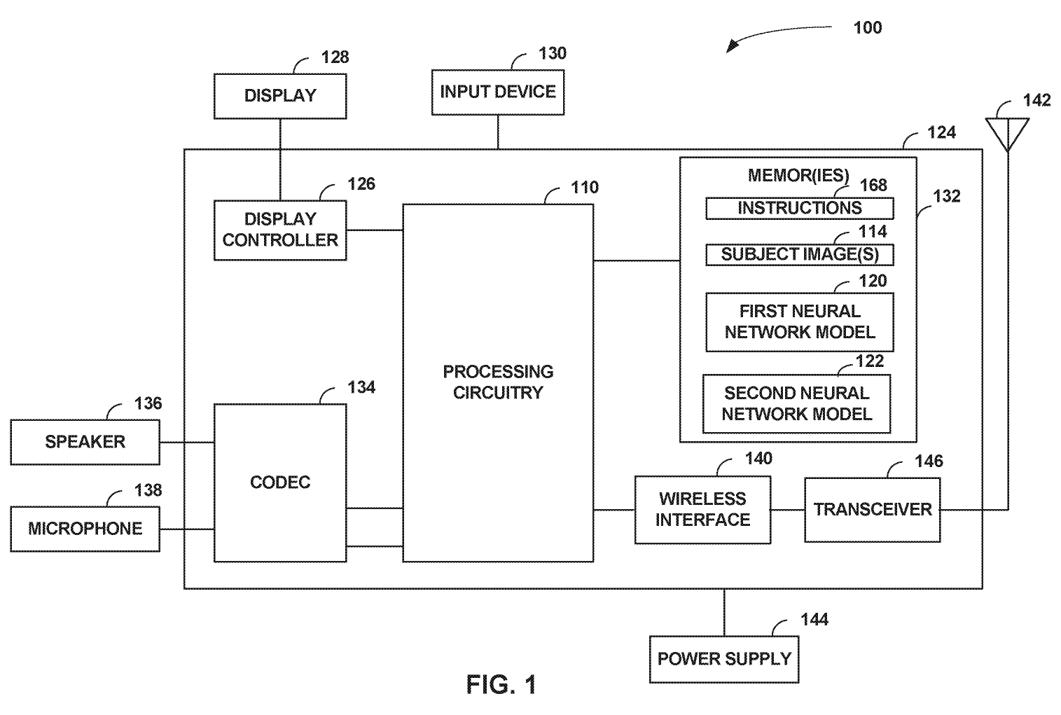

FIG. 1 is a block diagram illustrating an example of a device according to the techniques of this disclosure. In some examples, the device 100 may be a wireless communication device, such as a smartphone. In some examples, the device 100 may have more or fewer components than illustrated in FIG. 1. In an illustrative aspect, the device 100 may perform one or more operations described with reference to the techniques discussed in this disclosure.

In some examples, the device 100 includes processing circuitry 110 (e.g., a processor), such as a central processing unit (CPU) or a digital signal processor (DSP), coupled to one or more memories 132. The one or more memories 132 includes instructions 168 (e.g., executable instructions) such as computer-readable instructions or processor-readable instructions. The instructions 168 may include one or more instructions that are executable by a computer, such as the processing circuitry 110. The one or more memories 132 also includes the first neural network model 120 and the second neural network model 122.

As described in more detail, processing circuitry 110 may apply (e.g., execute) first neural network model 120 to generate subject regional information based on receiving an input to generate an image that includes a plurality of subjects. Processing circuitry 110 may apply second neural network model 122 to the subject regional information to generate the image that includes the plurality of subjects. The subject regional information may provide information to the second neural network model 122 that the second neural network model 122 can utilize to avoid mixing artifacts, misalignment, and other types of distortions.

Examples of first neural network model 120 and second neural network model 122 include a diffusion models, generative adversarial network (GAN) models, convolutional neural network (CNN) models, variational autoencoder (VAE), etc. In some examples, second neural network model 122 may not be tuned for the specific subject images that are to be used for generating the image that includes the subjects (e.g., zero-shot inference). However, second neural network model 122 may be tuned for the specific subject images as well. If processing circuitry 110 provides limited compute capabilities, first neural network model 120 and second neural network model 122 may not be tuned network models, but it may still be possible for first neural network model 120 and second neural network model 122 to be tuned network models. If processing circuitry 110 provides relatively large compute capabilities, first neural network model 120 and second neural network model 122 may be tuned network models, but it may still be possible for first neural network model 120 and second neural network model 122 to be non-tuned network models.

The device 100 may include a display controller 126 that is coupled to the processing circuitry 110 and to a display 128. A coder/decoder (CODEC) 134 may also be coupled to the processing circuitry 110. A speaker 136 and a microphone 138 may be coupled to the CODEC 134.

FIG. 1 also illustrates that a wireless interface 140, such as a wireless controller, and a transceiver 146 may be coupled to the processing circuitry 110 and to an antenna 142, such that wireless data received via the antenna 142, the transceiver 146, and the wireless interface 140 may be provided to the processing circuitry 110. In some examples, the processing circuitry 110, the display controller 126, the one or more memories 132, the CODEC 134, the wireless interface 140, and the transceiver 146 are included in a system-in-package or system-on-chip device 124. In some examples, an input device 130 and a power supply 144 are coupled to the system-on-chip device 124. Moreover, in an example, as illustrated in FIG. 1, the display 128, the input device 130, the speaker 136, the microphone 138, the antenna 142, and the power supply 144 are external to the system-on-chip device 124. In some examples, each of the display 128, the input device 130, the speaker 136, the microphone 138, the antenna 142, and the power supply 144 may be coupled to a component of the system-on-chip device 124, such as an interface or a controller.

In some examples, the one or more memories 132 includes or stores the instructions 168 (e.g., executable instructions), such as computer-readable instructions or processor-readable instructions. For example, the one or more memories 132 may include or correspond to a non-transitory, computer readable medium storing the instructions 168. The instructions 168 may include one or more instructions that are executable by a computer, such as the processing circuitry 110. In some examples, the device 100 includes a non-transitory, computer readable medium (e.g., the one or more memories 132) storing instructions (e.g., the instructions 168) that, when executed by one more processors (e.g., the processing circuitry 110), may cause the one or more processors to perform operations described in this disclosure.

Various functions performed by the one or more components of the systems are described with reference to certain components or circuitry. This division of components and circuitry is for illustration only. In an alternate aspect, a function performed by a particular component may be divided amongst multiple components. Moreover, in an alternate aspect, two or more components described with reference to FIG. 1 may be integrated into a single component. Each component described with reference to FIG. 1 may be implemented using hardware (e.g., a field-programmable gate array (FPGA) device, an application-specific integrated circuit (ASIC), a DSP, a controller, etc.), software (e.g., instructions executable by a processor), or any combination thereof.

One or more of the disclosed aspects may be implemented in a system or an apparatus, such as the device 100, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 100 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, the device 100 may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

The techniques of the disclosure are applicable to on-device personalization, allowing users of mobile devices to generate new images. Other commercial applications may include image generation systems for amusement parks or tourist places. The generated images may be suitable for use in applications provided by entities such as Meta, Snap, Tiktok, or Instagram.

In accordance with one or more examples, processing circuitry 110 may receive an input to generate an image that includes a plurality of subjects. In some examples, the input may include information indicative of the number of subjects, and other contextual information (e.g., location, action performed by the subjects, etc.). The input may be a text-semantic input, but the techniques are not so limited. The input may also include information indicative of relative locations of the subjects (e.g., location of each of the subjects in the image).

Processing circuitry 110 may also receive respective images that include the respective subjects. For instance, one or more memories 132 may store subject images 114. Examples of subject images 114 may be thumbnail images of the face of the subject, a cropped image of the subject, etc. In some examples, it may be possible for first neural network model 120 to generate subject images 114, rather than subject images 114 being images of real-life subjects. Also, in some examples, subject images 114 may be an image of group of subjects (e.g., family portrait) rather than one of subject images 114 being for one subject, another one of subject images 114 being for another subject, and so forth.

That is, it may be possible to upload a group picture, and each subject from the group picture may be removed to generate the image that includes the subjects. For instance, a family portrait can be leveraged to generate a new image in which the subjects in the family portrait are displayed in another location.

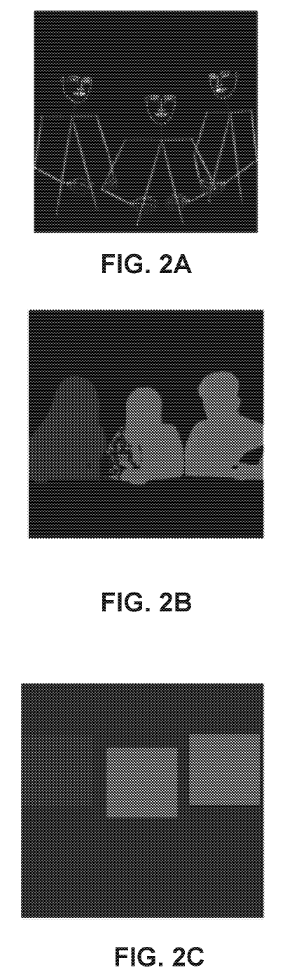

Processing circuitry 110 may apply first neural network model 120 to the input to generate subject regional information. There may be various examples of first neural network model 120 that are configured to generate subject regional information. In one example, first neural network model 120 may be a text-to-region generative model. Examples of subject regional information include one or more pose images, each pose image representing a pose of the subjects, one or more segmentation images, each segmentation image representing a segmentation of the subjects, and one or more region images, each region image representing a region encompassed by the subjects. Examples of subject regional information is illustrated in FIGS. 2A–2C.

FIGS. 2A–2C are conceptual diagrams illustrating examples of subject regional information. In FIGS. 2A–2C, assume that the input (e.g., text-semantic input) is “3 hikers in a forest.” FIG. 2A illustrates an example pose image of the pose of the three subjects. FIG. 2B illustrates an example segmentation image showing the segmentation of the three subjects. FIG. 2C illustrates an example of region image showing the region (e.g., bounding box) of where the three subjects are to be located in the generated image. FIGS. 2A–2C are one example, and in some examples, processing circuitry 110 via first neural network model 120 may generate a plurality of pose images like FIG. 2A but with the subjects in different poses, a plurality of segmentation images like FIG. 2B but with the subjects segmented in different way, and/or a plurality of region images like FIG. 2C but with the subjects in different regions.

In the example pose image of FIG. 2A, the pose of the three subjects is shown, including keypoints on their faces (e.g., eyes, nose, lips, etc.). In some examples, there may be visual gains if the pose image does not include keypoints on faces. Rather, only pose information of the body is included in the pose image (e.g., the spatial information of the body). That is, the pose image may be same as FIG. 2A but without the face. In some cases, if the keypoints on the face are different than the proportions of the face, there may be drop in quality of the generated image because the input faces may not align well with the keypoints in the pose image. Accordingly, in some examples, but not necessarily all examples, it may be possible to generate pose image, like FIG. 2A, but without keypoints in the face.

Referring back to FIG. 1, processing circuitry 110 may apply second neural network model 122 to the subject regional information to generate the image that includes the subjects. One example of the second neural network 122 is a large vision model (LVM), such as OmniGen, Stable-DiffusionXL, etc. For example, processing circuitry 110 may apply the second neural network model 122 to at least one of the one or more pose images, one or more segmentation images, and one or more region images to generate the image. The second neural network model 122 may also receive the subject images 114 as input.

In some examples, second neural network model 122 may also receive, via the input (e.g., text-semantic input), information indicative of relative locations of the subjects. For example, the information indicative of the relative locations may be “The person on the left image is |image1|…middle is |image2|…right is |image3|.” In this example, image1, image2, and image3 may be subject images stored as subject images 114. To apply the second neural network model, the processing circuitry 110 may be configured to apply the second neural network model 122 to the subject regional information utilizing the information indicative of the relative locations of the subjects as input to the second neural network model 122 to generate the image.

The second neural network model 122 may also receive the other contextual information such as location, subject movement, etc. The second neural network model 122 may utilize the subject regional information from first neural network model 120, subject images 114, and contextual information from the input (e.g., text-semantic input) to generate the image the includes the subjects.

In some examples, first neural network model 120 may generate one type of subject regional information (e.g., one pose image, one segmentation image, or one region image). The second neural network model 122 may then utilize that one type of subject regional information. In some examples, the first neural network model 120 may generate a plurality of one type of subject regional information and/or a plurality of different types of subject regional information. For example, the first neural network model 120 may generate a plurality of pose images, a plurality of segmentation images, a plurality of region images, or any combination of pose image(s), segmentation image(s), and region image(s). In such examples, processing circuitry 110 may receive a selection of at least one of a first pose image from the one or more pose images, a first segmentation image of the one or more segmentation images, and a first region image of the one or more region images. To apply the second neural network model 122, the processing circuitry 110 may be configured to apply the second neural network model 122 to at least one of the first pose image, the first segmentation image, and the first region image.

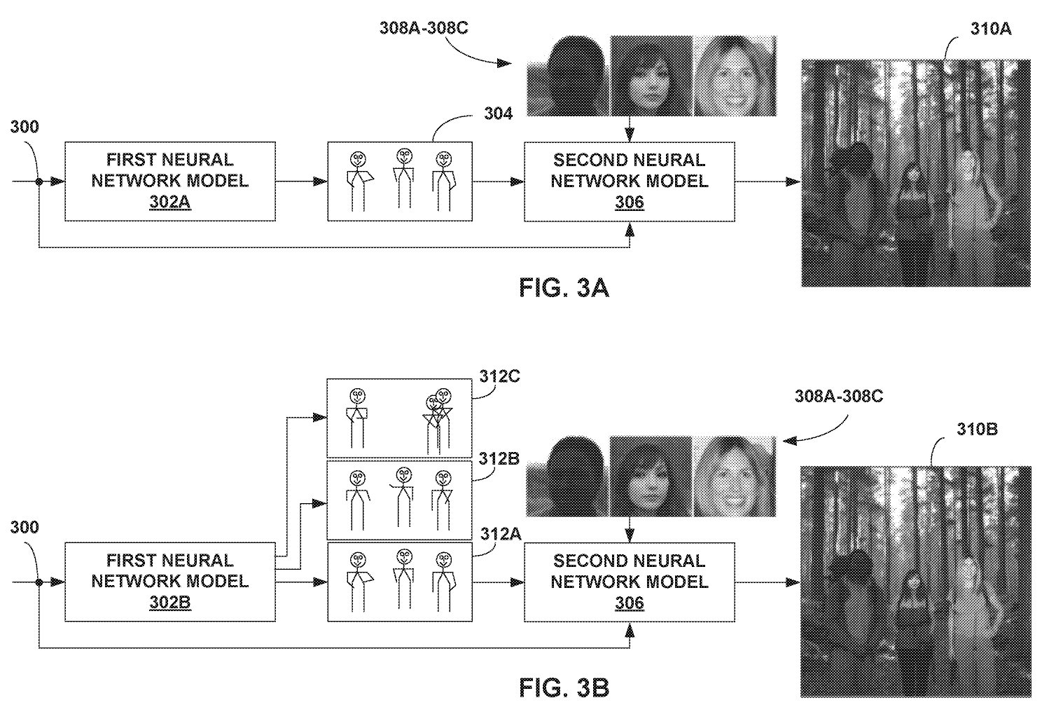

FIG. 3A is a flow diagram illustrating an example of generating an image according to the techniques of this disclosure. The example of FIG. 3A may be considered as an automated technique (e.g., little to no user intervention after providing input) to generate an image 310A with subjects, where image 310A is an AI/ML generated image. FIG. 3B is a flow diagram illustrating another example of generating an image according to the techniques of this disclosure. The example of FIG. 3B may be considered as a semi-automated technique (e.g., more user intervention after providing input than automated technique) to generate an image 310B with subjects, where image 310B is an AI/ML generated image. For ease of understanding, FIGS. 3A and 3B are described together. Processing circuitry 110 may perform the example operations of FIGS. 3A and 3B.

In FIGS. 3A and 3B, a user may provide prompt 300 (e.g., via input device 130, display 128, or microphone 138). Prompt 300 is an example of an input to generate an image that includes a plurality of subjects. The subjects may be human subjects, but the techniques are not so limited, and animals or objects are additional examples of the subjects.

Prompt 300 may be a text-semantic input, such as “3 hikers in the forest + The person on the left is |image1|…middle is |image2|…right is |image3|.” A text-semantic input is one example, and other examples of prompt 300 are possible including verbal input. In some examples, prompt 300 may be generated in multi-stages. For instance, the user provides a verbal input that a verbal-to-text engine executing on processing circuitry 110 converts to a text input, and this text input is prompt 300.

In the example of FIGS. 3A and 3B, prompt 300 may include information indicative of a number of subjects to generate in the image 310A or 310B. For instance, prompt 300 specifies three subjects in “3 hikers in the forest.” Prompt 300 may also include information indicative of relative locations of the subjects. For instance, prompt 300 specifies “The person on the left is |image1|…middle is |image2|…right is |image3|.” There may be other ways to provide relative locations, including relative locations that do not require the locations to be relative to other subjects, but could include relative locations like “in front of trees,” or other such location information.

Prompt 300 also includes other contextual information useful for generating image 310A or image 310B, such as “hikers in the forest.” Other contextual information or location information in prompt 300 may include actions performed by the subjects like jumping, kneeling, running, etc. The number of subjects, location information, and other contextual information may all be used together to generate image 310A or 310B.

In FIGS. 3A and 3B, examples of images used for generating image 310A (FIG. 3A) or 310B (FIG. 3B) includes subject images 308A–308C, shown respectively. One or more memories 132 may store subject images 308A–308C (e.g., subject images 308A–308C are examples of subject images 114). In FIGS. 3A and 3B, |image1| may be subject image 308A, |image2| may be subject image 308B, and |image3| may be subject image 308C. In some examples, prompt 300 may include information that identifies which ones of images 308A–308C are which ones of image1, image2, or image3. In some examples, the user may tag image 308A as image1, image 308B as image2, and image 308C as image3. Other ways in which to provide regional association of images 308A–308C to image1, image2, and image3 is possible.

In FIG. 3A, first neural network model 302A (e.g., via execution on processing circuitry 110) may receive prompt 300, and in FIG. 3B, first neural network model 302B (e.g., via execution on processing circuitry 110) may receive prompt 300. First neural network model 302A and 302B may be examples of first neural network model 120. Processing circuitry 110 may apply a first neural network model 302A or 302B to the input (e.g., prompt 300) to generate subject regional information 304 (FIG. 3A) or subject regional information 312A–312C. First neural network model 302A or first neural network model 302B may be considered as text-to-region generative model for generating subject regional information. As described, examples of the subject regional information include one or more pose images, each pose image representing a pose of the subjects, one or more segmentation images, each segmentation image representing a segmentation of the subjects, and one or more region images, each region image representing a region encompassed by the subjects.

First neural network model 302A may be configured to generate one image of one type of subject regional information. For instance, subject regional information 304 may be one pose image (e.g., like FIG. 2A). Other examples of subject regional information 304 may be one segmentation image (e.g., like FIG. 2B) or one region image (e.g., like FIG. 2C).

First neural network model 302B, however, may be configured to generate a plurality of images of one type of subject regional information, one image of a plurality of types of subject regional information, or a plurality of images of a plurality of types of subject regional information. For instance, subject regional information 312A–312C may be a plurality of pose images (e.g., plurality of images like FIG. 2A), where the subjects are located in different poses or locations. Other examples of subject regional information 312A–312C may be (1) a plurality of segmentation images (e.g., plurality of images like FIG. 2B), a plurality of region images (e.g., plurality of images like FIG. 2C), (2) one pose image, one segmentation image, and one region image, or (3) one or more pose images, one or more segmentation images, and one or more region images, or any combination.

In the example of FIG. 3B, processing circuitry 110 may receive a selection of at least one of a first pose image from the one or more pose images, a first segmentation image of the one or more segmentation images, and a first region image of the one or more region images. For instance, subject regional information 312A–312C may be considered as pose images 312A–312C, and processing circuitry 110 may receive a selection of a first pose image from pose images 312A–312C. In examples where subject regional information is one or more pose images, one or more segmentation images, or one or more region images, processing circuitry 110 may receive a selection of at least one of these images.

Processing circuitry 110 may receive the selection through input device 130, display 128, or microphone 138. Because user selection is utilized in the example of FIG. 3B, but may not be needed in the example of FIG. 3A, the example of FIG. 3A may be considered as automated, and the example of FIG. 3B may be considered as semi-automated. This semi-automated approach provides a technical benefit, as receiving a user selection of one of several generated pose images (e.g., subject regional information 312A–312C) is computationally and operationally simpler for a user than manually creating or curating an entire pose conditioning from scratch.

Second neural network model 306 may receive subject regional information 304 (FIG. 3A) or the selected subject regional information 312A–312C (e.g., subject regional information 312A) (FIG. 3B). Second neural network model 306 is an example of second neural network model 122, and may be a unified LVM (large vision model). In some examples, second neural network model 306 may be commercially or otherwise available LVM that is configured to receive subject regional information 304 or one of 312A–312C and output image 310A or 310B.

To generate image 310A or 310B, second neural network model 306 may also receive the input (e.g., prompt 300) or at least part of the input. For instance, second neural network model 306 may receive prompt 300 that indicates that there are three subjects, that the three subjects are hikers, that the hikers are in a forest, and that subject images 308A–308C are for the three hikers, as well as the information that image1 is on the left, image2 is in the middle, and image3 is on the right.

Second neural network model 306 may be a zero-shot (e.g., not tuned) or tuned neural network model. For instance, in zero-shot inference, second neural network model 306 may not be trained using specific images 308A–308C. In a tuned neural network model, second neural network model 306 may be trained using images 308A–308C.

In some cases, if prompt 300 were directly provided to second neural network model 306, without the use of first neural network model 302A or 302B, second neural network model 306 may still generate an image. However, this image may be misaligned, there may be mixing of artifacts (e.g., the hair of subject image 308C becomes the hair of subject image 308B), there may be copying of subject images 308A–308C, the subject images 308A–308C may appear distorted in the image, and other such image distortions.

With the example techniques, subject regional information 304 or selected one of subject regional information 312A–312C may form as an anchor, contour, bounding box, keypoints, etc. that second neural network model 306 can leverage to better generate image 310A or 310B. In this manner, by pre-processing the input (e.g., prompt 300) to generate subject regional information 304 or subject regional information 312A–312C, the example techniques may improve AI/ML based image generation.

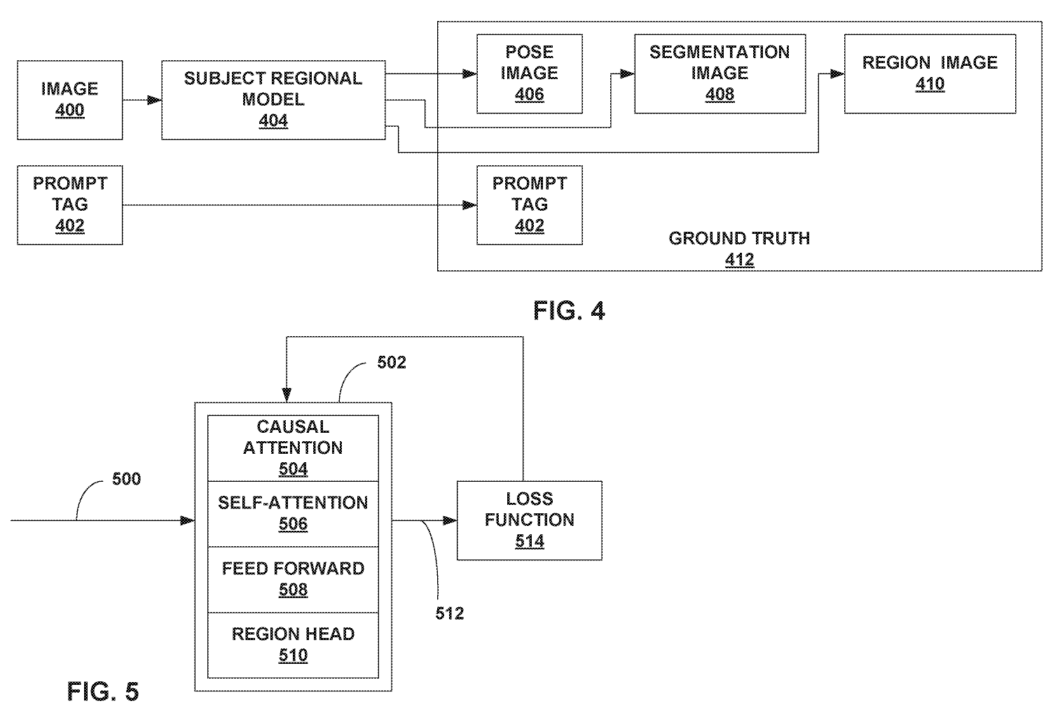

FIG. 4 is a flow diagram illustrating an example of generating ground truth images for training a neural network model for generating subject regional information. FIG. 5 is a conceptual diagram illustrating an example of a neural network model for generating subject regional information. That is, FIGS. 4 and 5 illustrate example ways to generate first neural network model 302A, 302B, or 120. For example, FIG. 5 illustrates neural network model 502 of FIG. 5 that is trained using ground truth 412 of FIG. 4. Once trained, neural network model 502 is an example of first neural network model 302A, 302B, or 120.

In one or more examples, ground truth 412 is the ground truth data that the subject regional information 512 is tested against, such that loss function 514 can update the weights and offsets of neural network model 502. The generation of ground truth 412 and the training of neural network model 502 may be performed on a device other than device 100, in some examples. For instance, a cloud computing system may generate ground truth 412 and train neural network model 502, and then output the trained neural network model to device 100 as first neural network model 120. There may be other ways in which to generate ground truth 412 and train neural network model 502. For ease, the examples of FIGS. 4 and 5 are described with respect to a cloud computing system.

The cloud computing system may receive image 400, which may be a stock image of a plurality of subjects in a location. As an example, image 400 may be three people reading in a library. The cloud computing system may tag image 400 with an associated prompt tag 402. As one example, prompt tag 402 may be text that describes image 400 (e.g., provides semantics for image 400). For instance, prompt tag 402 may be “three people reading in a library,” which corresponds to the image content of image 400.

Subject regional model 404, executing on the cloud computing system, receives image 400 and may generate one or more of pose image 406, segmentation image 408, and region image 410 for image 400. Pose image 406, segmentation image 408, and region image 410 may be similar to FIGS. 2A–2C, respectively, but for image 400.

Subject regional model 404 may be a commercially available neural network model that is designed to generate pose images, segmentation images, and/or region images. One example of subject regional model 404 is a vision understanding model, such as GroundingDINO, SAM, SAM2, YOLO, and OpenPose. Subject regional model 404 may be different the first neural network model 302A, 302B, or 120 in the sense that subject regional model 404 receives actual images and generates pose images, segmentation images, and/or region images, whereas first neural network model 302A, 302B, or 120 receive non-image prompts such as text-semantic inputs, verbal inputs, etc. However, in some cases, subject regional model 404 may be a class or type of first neural network model 302A, 302B, or 120.

The cloud computing system may provide subject regional model 404 with hundreds, thousands, or even more images like image 400, where each image is tagged with a prompt tag like prompt tag 402. In this manner, the cloud computing system may generate a library of ground truth 412, where each respective one of the pose images, segmentation images, and region images are tagged with respective ones of the prompt tags.

The description of FIG. 4 is one example way in which to generate a library of ground truth 412. There may be other ways in which to generate the library of ground truth 412, and the example techniques are not limited to any particular manner in which to generate ground truth 412.

For training neural network model 502, the cloud computing system may input prompt 500. Prompt 500 may be one of the prompt tags 402 in the library of ground truth 412. Neural network model 502 may generate subject regional information 512. Loss function 514 may compare subject regional information 512 to the pose image 406, segmentation image 408, or region image 410 that is associated with prompt 500. Based on the difference, the cloud computing system may update the weights and offsets of neural network model 502. The cloud computing system may repeat such operations until subject regional information 512 matches pose image 406, segmentation image 408, or region image 410 (e.g., until the loss function 514 is minimized).

In some examples, where subject regional information 512 is a pose image or a region image, loss function 514 may be mean-squared-error (MSE) based loss function. In some examples, where subject regional information 512 is a segmentation image, loss function 514 may be a cross-entropy based loss function.

An example structure of neural network model 502 is illustrated in FIG. 5. In general, neural network model 502 may be a diffusion based model, a GAN based model, a CNN based model, or other model types. Accordingly, the example structure of neural network model 502 illustrated in FIG. 5 is one example, and should not be considered limiting.

In the example of FIG. 5, neural network model 502 includes a causal attention block 504, a self-attention block 506, a feed forward block 508, and a region head block 510. Region head block 510 may be configured to selectively generate one or more of a pose image, segmentation image, or region image as subject regional information 512.

Causal attention block 504 may be configured to consider previous and current inputs in prompt 500, when processing any given token of prompt 500. Self-attention block 506 may be a mechanism that allows neural network model 502 to dynamically weigh the importance of different parts of prompt 500 when making predictions. Feed forward block 508 may ensure that there are not loops in the passing of data through nodes of neural network model 502.

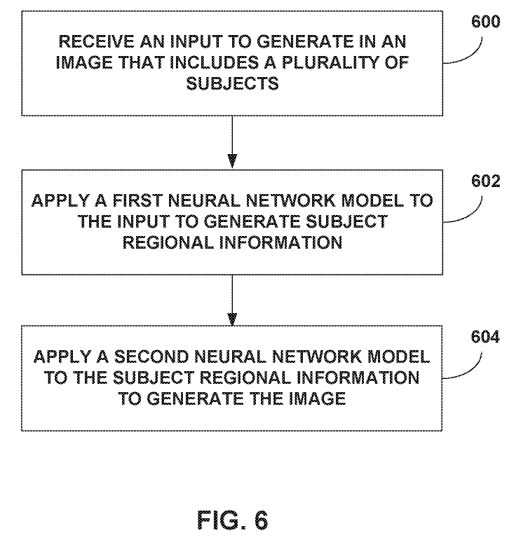

FIG. 6 is a flowchart illustrating an example method of generating an image according to the techniques of this disclosure. For ease, the example of FIG. 6 is described with respect to processing circuitry 110 and one or more memories 132 of FIG. 1, including examples of FIGS. 3A and 3B. For instance, as described above, processing circuitry 110 may be coupled to one or more memories 132, and processing circuitry 110 may be configured to perform one or more examples described in this disclosure.

For example, processing circuitry 110 may receive an input (e.g., prompt 300) to generate an image (e.g., image 310A or 310B) that includes a plurality of subjects (600). As an example, the input may be a text-semantic input, and the text-semantic input includes information indicative of a number of subjects to generate in the image. In some examples, the input further includes information indicative of relative locations of the subjects. For instance, an example of the input may be “three hikers in a forest where the |image1| is on the left, |image2| is in the middle, and |image3| is in the right.” In some examples, processing circuitry 110 may also receive respective images (e.g., subject images 308A–308C) that include the respective subjects.

Processing circuitry 110 may be configured to apply a first neural network model (e.g., first neural network model 302A or 302B) to the input (e.g., prompt 300) to generate subject regional information (e.g., subject regional information 304 or 312A–312B) (602). The first neural network model may be a text-to-region generative model. Also, the first neural network model may be generated using the example techniques described with respect to FIGS. 4 and 5.

As one example, to apply the first neural network model to the input to generate the subject regional information, the processing circuitry 110 may be configured to apply the first neural network model to the input to generate at least one of: one or more pose images, each pose image representing a pose of the subjects, one or more segmentation images, each segmentation image representing a segmentation of the subjects, and one or more region images, each region image representing a region encompassed by the subjects. As another example, the subject regional information may be one pose image, or may be a plurality of pose images.

In some examples, such as where the subject regional information includes a plurality of images, processing circuitry 110 may receive a selection of at least one of a first pose image from the one or more pose images, a first segmentation image of the one or more segmentation images, and a first region image of the one or more region images. As another example, processing circuitry 110 may receive a selection of a first pose image from the plurality of pose images

Processing circuitry 110 may be configured to apply a second neural network model (e.g., second neural network model 306) to the subject regional information to generate the image (e.g., image 310A or image 310B) (604). The second neural network model may be a large vision model (LVM).

As one example, to apply the second neural network model, processing circuitry 110 may be configured to apply the second neural network model to at least one of the one or more pose images, one or more segmentation images, and one or more region images to generate the image. For instance, in examples where a particular image is selected, processing circuitry 110 may be configured to apply the second neural network model to at least one of the first pose image, the first segmentation image, and the first region image (e.g., the selected image).

In examples where the first neural network outputs one pose image, to apply the second neural network model, processing circuitry 110 may be configured to apply the second neural network model to the one pose image to generate the image (e.g., image 310A). In examples where the first neural network outputs a plurality of pose images, where a first pose image is selected by the user, to apply the second neural network model, processing circuitry 110 may be configured to apply the second neural network model to the first pose image to generate the image (e.g., image 310B).

As described above, the input (e.g., prompt 300) may also include subject regional information. In some examples, to apply the second neural network model, processing circuitry 110 may be configured to apply the second neural network model to the subject regional information utilizing the information indicative of the relative locations of the subjects as input to the second neural network model to generate the image.

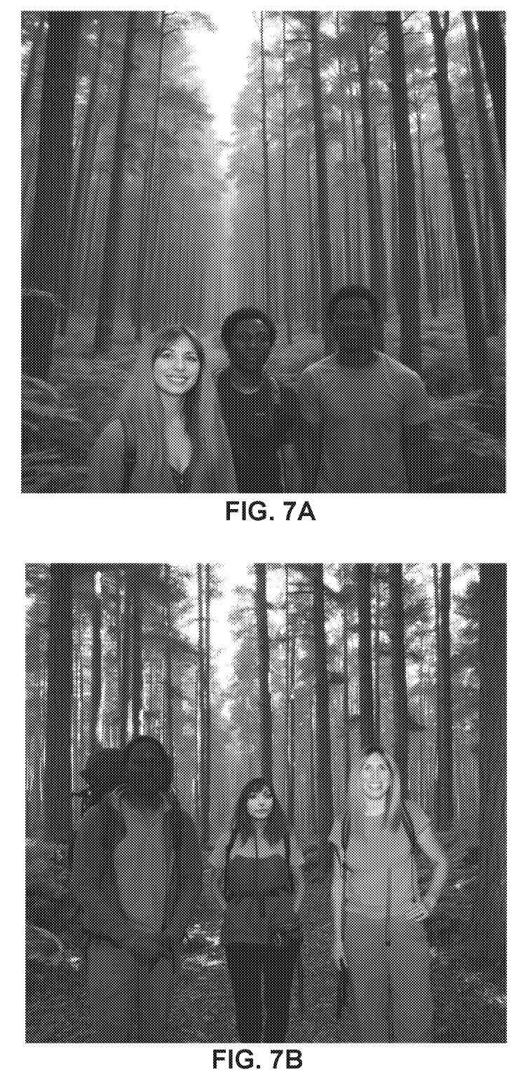

FIGS. 7A and 7B are images illustrating different generated images. FIG. 7A may be generated without the use of a first neural network model. For example, FIG. 7A is generated without using first neural network model 302A or 302B. Rather, prompt 300 may be a direct input to second neural network model 306 without subject regional information 304 or one of subject regional information 312A–312C also being an input.

As can be seen in FIG. 7A, there is artifact mixing of subject image 308B and 308C, where hair of subject image 308B is that of subject image 308C. Also, in FIG. 7A, subject image 308A is rendered twice. FIG. 7B is a copy of image 310A or 310B, and appears to better capture the subject images than FIG. 7A (e.g., without artifact mixing, misalignment, or other distortions).

The example techniques were tested using different examples of second neural network model 306. Examples of the second neural network model 306 includes LoRA, MIP-Adapter, UniPortrait, RectifiID, and OmniGen. Each example of the second neural network model 306 was tested in a first condition (e.g., task 1) where subject regional information 304 or one of subject regional information 312A–312C were not inputs and only prompt 300 was the input and in a second condition (e.g., task 2) where subject regional information 304 or one of subject regional information 312A–312C was an input in addition to prompt 300.

Task 2 consistently performed better than task 1. For instance, for each example of the second neural network model 306, task 2 generated the current number of people. For each example of the second neural network model 306, the image output from task 1 and the image output from task 2 were input into a model that generates a human preference score (HPS). Consistently, the image output from task 2 was preferred over the output from task 1. For each example of the second neural network model 306, the image output from task 1 and the image output from task 2 were tested to determine if the people in the output image were performing the instructed action. Again, the people in the image output from task 2 were overall more often performing the instructed action as compared to the image output from task 1.

For example, on a test set of prompts requesting one to five humans, task 1 may achieve an accuracy (correct number of people generated) of approximately 53.4%, an identification (ID) similarity (average best ID match per person) of approximately 40.3%, and a HPS of approximately 27.15. These metrics indicate poor performance in accurately generating the correct number of subjects and maintaining subject fidelity. In one example test using the OmniGen model as second neural network model 306, task 1 achieved an accuracy (correct number of people) of 53.4% and an HPS score of 27.15. Applying the techniques of the disclosure to provide pose guidance (an automated example of task 2, as in FIG. 3A) improved performance to 65.5% accuracy and an HPS score of 28.08. Furthermore, applying the techniques with human selection of the pose (a semi-automated example of task 2, as in FIG. 3B) further improved performance to 74.8% accuracy and an HPS of 28.45.

Although one or more of FIGS. 1–6 may illustrate systems, apparatuses, and/or methods according to the teachings of the disclosure, the disclosure is not limited to these illustrated systems, apparatuses, and/or methods. One or more functions or components of any of FIGS. 1–6 as illustrated or described herein may be combined with one or more other portions of another of FIGS. 1–6. Accordingly, no single implementation described herein should be construed as limiting and implementations of the disclosure may be suitably combined without departing from the disclosure. As an example, one or more operations described with reference to FIGS. 1–6 may be optional, may be performed at least partially concurrently, and/or may be performed in a different order than shown or described.

This disclosure includes the following non-limiting clauses.

Clause 1A. A device for image generation, the device comprising: one or more memories; and processing circuitry coupled to the one or more memories and configured to: receive an input to generate an image that includes a plurality of subjects; apply a first neural network model to the input to generate subject regional information; and apply a second neural network model to the subject regional information to generate the image.

Clause 2A. The device of clause 1A, wherein the input comprises a text-semantic input, and wherein the text-semantic input includes information indicative of a number of subjects to generate in the image, and wherein the second neural network model is a large vision model (LVM).

Clause 3A. The device of any of clauses 1A and 2A, wherein the processing circuitry is configured to receive respective images that include the respective subjects.

Clause 4A. The device of any of clauses 1A–3A, wherein to apply the first neural network model to the input to generate the subject regional information, the processing circuitry is configured to apply the first neural network model to the input to generate at least one of: one or more pose images, each pose image representing a pose of the subjects; one or more segmentation images, each segmentation image representing a segmentation of the subjects; and one or more region images, each region image representing a region encompassed by the subjects, and wherein to apply the second neural network model, the processing circuitry is configured to apply the second neural network model to at least one of the one or more pose images, one or more segmentation images, and one or more region images to generate the image.

Clause 5A. The device of clause 4A, wherein the processing circuitry is further configured to: receive a selection of at least one of a first pose image from the one or more pose images, a first segmentation image of the one or more segmentation images, and a first region image of the one or more region images, wherein to apply the second neural network model, the processing circuitry is configured to apply the second neural network model to at least one of the first pose image, the first segmentation image, and the first region image.

Clause 6A. The device of any of clauses 1A and 2A, wherein the subject regional information comprises one pose image, and wherein to apply the second neural network model, the processing circuitry is configured to apply the second neural network model to the one pose image to generate the image.

Clause 7A. The device of any of clauses 1A and 2A, wherein the subject regional information comprises a plurality of pose images, wherein the processing circuitry is configured to receive a selection of a first pose image from the plurality of pose images, and wherein to apply the second neural network model, the processing circuitry is configured to apply the second neural network model to the first pose image to generate the image.

Clause 8A. The device of any of clauses 1A–7A, wherein the input further includes information indicative of relative locations of the subjects, and wherein to apply the second neural network model, the processing circuitry is configured to apply the second neural network model to the subject regional information utilizing the information indicative of the relative locations of the subjects as input to the second neural network model to generate the image.

Clause 9A. The device of any of clauses 1A–8A, wherein the first neural network model comprises a text-to-region generative model.

Clause 10A. A method of image generation, the method comprising: receiving, with processing circuitry, an input to generate an image that includes a plurality of subjects; applying, with the processing circuitry, a first neural network model to the input to generate subject regional information; and applying, with the processing circuitry, a second neural network model to the subject regional information to generate the image.

Clause 11A. The method of clause 10A, wherein the input comprises a text-semantic input, and wherein the text-semantic input includes information indicative of a number of subjects to generate in the image, and wherein the second neural network model is a large vision model (LVM).

Clause 12A. The method of any of clauses 10A and 11A, further comprising receiving respective images that include the respective subjects.

Clause 13A. The method of any of clauses 10A–12A, wherein applying the first neural network model to the input to generate the subject regional information comprises applying the first neural network model to the input to generate at least one of: one or more pose images, each pose image representing a pose of the subjects; one or more segmentation images, each segmentation image representing a segmentation of the subjects; and one or more region images, each region image representing a region encompassed by the subjects, and wherein applying the second neural network model comprises applying the second neural network model to at least one of the one or more pose images, one or more segmentation images, and one or more region images to generate the image.

Clause 14A. The method of clause 13A, further comprising: receiving a selection of at least one of a first pose image from the one or more pose images, a first segmentation image of the one or more segmentation images, and a first region image of the one or more region images, wherein applying the second neural network model comprises applying the second neural network model to at least one of the first pose image, the first segmentation image, and the first region image.

Clause 15A. The method of any of clauses 10A and 11A, wherein the subject regional information comprises one pose image, and wherein applying the second neural network model comprises applying the second neural network model to the one pose image to generate the image.

Clause 16A. The method of any of clauses 10A and 11A, wherein the subject regional information comprises a plurality of pose images, the method further comprising receiving a selection of a first pose image from the plurality of pose images, and wherein applying the second neural network model comprises applying the second neural network model to the first pose image to generate the image.

Clause 17A. The method of any of clauses 10A–16A, wherein the input further includes information indicative of relative locations of the subjects, and wherein applying the second neural network model comprises applying the second neural network model to the subject regional information utilizing the information indicative of the relative locations of the subjects as input to the second neural network model to generate the image.

Clause 18A. The method of any of clauses 10A–17A, wherein the first neural network model comprises a text-to-region generative model.

Clause 19A. A computer-readable storage medium storing instructions thereon that when executed cause one or more processors to perform the method of any of clauses 10A–18A.

Clause 20A. A device comprising means for performing the method of any of clauses 10A–18A.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise random access memory (RAM), read-only memory (ROM), electrically erasable programmable read-only memory (EEPROM), compact disc read-only memory (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image generation, the device comprising:
one or more memories; and
processing circuitry coupled to the one or more memories and configured to:
receive an input to generate an image that includes a plurality of subjects;
apply a first neural network model to the input to generate subject regional information; and
apply a second neural network model to the subject regional information to generate the image.

2. The device of claim 1, wherein the input comprises a text-semantic input, and wherein the text-semantic input includes information indicative of a number of subjects to generate in the image, and wherein the second neural network model is a large vision model (LVM).

3. The device of claim 1, wherein the processing circuitry is configured to receive respective images that include the respective subjects.

4. The device of claim 1,
wherein to apply the first neural network model to the input to generate the subject regional information, the processing circuitry is configured to apply the first neural network model to the input to generate at least one of:
one or more pose images, each pose image representing a pose of the subjects;
one or more segmentation images, each segmentation image representing a segmentation of the subjects; and
one or more region images, each region image representing a region encompassed by the subjects, and
wherein to apply the second neural network model, the processing circuitry is configured to apply the second neural network model to at least one of the one or more pose images, one or more segmentation images, and one or more region images to generate the image.

5. The device of claim 4, wherein the processing circuitry is further configured to:
receive a selection of at least one of a first pose image from the one or more pose images, a first segmentation image of the one or more segmentation images, and a first region image of the one or more region images,
wherein to apply the second neural network model, the processing circuitry is configured to apply the second neural network model to at least one of the first pose image, the first segmentation image, and the first region image.

6. The device of claim 1, wherein the subject regional information comprises one pose image, and wherein to apply the second neural network model, the processing circuitry is configured to apply the second neural network model to the one pose image to generate the image.

7. The device of claim 1,
wherein the subject regional information comprises a plurality of pose images,
wherein the processing circuitry is configured to receive a selection of a first pose image from the plurality of pose images, and
wherein to apply the second neural network model, the processing circuitry is configured to apply the second neural network model to the first pose image to generate the image.

8. The device of claim 1, wherein the input further includes information indicative of relative locations of the subjects, and wherein to apply the second neural network model, the processing circuitry is configured to apply the second neural network model to the subject regional information utilizing the information indicative of the relative locations of the subjects as input to the second neural network model to generate the image.

9. The device of claim 1, wherein the first neural network model comprises a text-to-region generative model.

10. A method of image generation, the method comprising:
receiving, with processing circuitry, an input to generate an image that includes a plurality of subjects;
applying, with the processing circuitry, a first neural network model to the input to generate subject regional information; and
applying, with the processing circuitry, a second neural network model to the subject regional information to generate the image.

11. The method of claim 10, wherein the input comprises a text-semantic input, and wherein the text-semantic input includes information indicative of a number of subjects to generate in the image, and wherein the second neural network model is a large vision model (LVM).

12. The method of claim 10, further comprising receiving respective images that include the respective subjects.

13. The method of claim 10,
wherein applying the first neural network model to the input to generate the subject regional information comprises applying the first neural network model to the input to generate at least one of:
one or more pose images, each pose image representing a pose of the subjects;
one or more segmentation images, each segmentation image representing a segmentation of the subjects; and
one or more region images, each region image representing a region encompassed by the subjects, and
wherein applying the second neural network model comprises applying the second neural network model to at least one of the one or more pose images, one or more segmentation images, and one or more region images to generate the image.

14. The method of claim 13, further comprising:
receiving a selection of at least one of a first pose image from the one or more pose images, a first segmentation image of the one or more segmentation images, and a first region image of the one or more region images,
wherein applying the second neural network model comprises applying the second neural network model to at least one of the first pose image, the first segmentation image, and the first region image.

15. The method of claim 10, wherein the subject regional information comprises one pose image, and wherein applying the second neural network model comprises applying the second neural network model to the one pose image to generate the image.

16. The method of claim 10,
wherein the subject regional information comprises a plurality of pose images,
the method further comprising receiving a selection of a first pose image from the plurality of pose images, and
wherein applying the second neural network model comprises applying the second neural network model to the first pose image to generate the image.

17. The method of claim 10, wherein the input further includes information indicative of relative locations of the subjects, and wherein applying the second neural network model comprises applying the second neural network model to the subject regional information utilizing the information indicative of the relative locations of the subjects as input to the second neural network model to generate the image.

18. The method of claim 10, wherein the first neural network model comprises a text-to-region generative model.

19. One or more non-transitory computer-readable storage media storing instructions thereon that when executed cause one or more processors to:
receive an input to generate an image that includes a plurality of subjects;
apply a first neural network model to the input to generate subject regional information; and
apply a second neural network model to the subject regional information to generate the image.

20. The non-transitory computer-readable storage media of claim 19, wherein the input comprises a text-semantic input, and wherein the text-semantic input includes information indicative of a number of subjects to generate in the image, and wherein the second neural network model is a large vision model (LVM).
